(19) United States
(12) Patent Application Publication
(10) Pub. No.: US 2009/0147503 A1
(43) Pub. Date: Jun. 11, 2009

(54) Illuminated washable spoon with motion sensor

(76) Inventor: Patricia A. Bennett, Landale, PA (US)

Correspondence Address: Patricia Bennett, Apt. E-34, 1141 Snyder Road, Landale, PA, 19446, US

(21) Appl. No.: 11/999,413

(22) Filed: Dec. 5, 2007

(51) Int. Cl. F21V 33/00; G08B 5/00

(52) U.S. Cl. 362/119; 340/669

(57) ABSTRACT

The illuminated washable spoon includes a main spoon body having a concave distal portion and a handle portion. The handle portion is hollow and has a motion sensor and switch therein with connection to an illumination mechanism and adapted to turn the switch on in response to detected motion. An illumination mechanism is located within the handle portion. The illumination mechanism includes a power source, connection to the on/off switch and at least one light. When the spoon is moved and motion is sensed by the motion sensor, the motion sensor turns on the switch which illuminates at least one light.

### BACKGROUND OF INVENTION

a. Field of Invention

The invention relates generally to washable spoons for infants and toddlers and, more specifically, to plastic washable spoons that light up when child moves the spoon. The spoon has a motion sensor that closes a switch to effect illumination. An optional depressible portion may be pressed to deactivate the motion sensor.

b. Description of Related Art

The following patents are representative of mechanisms that change in response to consumption activity:

U.S. Pat. No. 6,359,559 to Rudell et al. describes a toy that activates an indicator while an end user consumes an edible substance. The toy includes a first electrode and a second electrode that are connected to the indicator. An electrical path is created between the first and second electrodes while the end user is consuming the consumable substance to close an electrical circuit with the indicator. The closed circuit activates the indicator.

U.S. Pat. No. 6,024,624 to Lee describes a novelty article for use in connection with liquid having a body and a generating mechanism, which is attached to the body, for generating electrically produced special effects, such audible sounds and visible lights, so as to enhance amusement for a user. The generating mechanism is provided with an activating mechanism, which is attached to the body, for activating the generating mechanism in response to contact by liquid. In accordance with one feature of the present invention, the body includes a drinking straw having a passageway for liquid. The activating mechanism has a pair of electrical contacts positioned in the passageway so as to activate the generating mechanism in response to liquid flow through the passageway.

U.S. Pat. No. 5,299,356 to Maxwell, III describes an eating utensil for counting the number of bites the user consumes in accordance with a specific diet plan regulating the fat intake by the user. The eating utensil has an illuminated display which changes depending on the number of bites consumed by the user. A push button is activated each time the user lifts up a fork full of food from the plate. An associated set of cards carries the names of the food items and the particular number of bites allowed to be taken depending on the fat content of that food item.

Notwithstanding the prior art, the present invention is neither taught nor rendered obvious thereby.

### SUMMARY OF INVENTION

The invention solves the problems and overcomes the drawbacks and deficiencies of prior art baby spoon devices by providing a motivational feature to a washable spoon, namely, illumination when held by the baby or toddler.

The present invention illuminated washable spoon includes a main spoon body having a concave distal portion and a handle portion. The handle portion is hollow and has a motion sensor and switch therein with connection to an illumination mechanism and adapted to turn the switch on in response to detected motion. An illumination mechanism is located within the handle portion. The illumination mechanism includes a power source, connection to the on/off switch and at least one light. When the spoon is moved and motion is sensed by the motion sensor, the motion sensor turns on the switch which illuminates at least one light.

In some preferred embodiments, the illumination mechanism includes a timing chip that shuts off the light after a preset illumination time period had transpired.

In some preferred embodiments, the handle portion includes a tail section that is removably attached to the handle portion.

In some preferred embodiments, the handle portion is translucent at least adjacent the at least one light.

In some preferred embodiments, the at least one light is positioned for its illumination to be directed toward the concave distal portion.

In some preferred embodiments, there is also a motion sensor activation/deactivation switch located in the handle and connected to the motion sensor switch that the depressible section may be depressed to cyclically depress the activation/deactivation switch to correspondingly activate and deactivate the motion sensor.

In some preferred embodiments, the motion sensor and on/off switch renders the illumination mechanism inoperable when the motion sensor is deactivated.

In some preferred embodiments, a depressible section in the handle and a motion sensor activation/deactivation switch located at the depressible section and connected to the motion sensor switch that the depressible section may be depressed to cyclically depress the activation/deactivation switch to corresponding activate and deactivate the motion sensor.

In some preferred embodiments, the motion sensor and on/off switch renders the illumination mechanism inoperable when the motion sensor is deactivated.

In some preferred embodiments, the main spoon body is formed in two parts that have been permanently bonded and sealed to one another.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a partially cut side view of an embodiment of an illuminated washable plastic spoon according to the present invention, illustrating its internal functional aspects and components;

FIG. 2 is a partially cut partial side view of another present invention illuminated washable spoon handle portion;

FIG. 3 is a schematic diagram of present invention illuminated washable spoon features; and,

FIG. 4 is a partially cut partial side view of another present invention illuminated washable spoon handle portion similar to those described, but having multiple lights and sound.

### DETAILED DESCRIPTION OF THE EMBODIMENTS

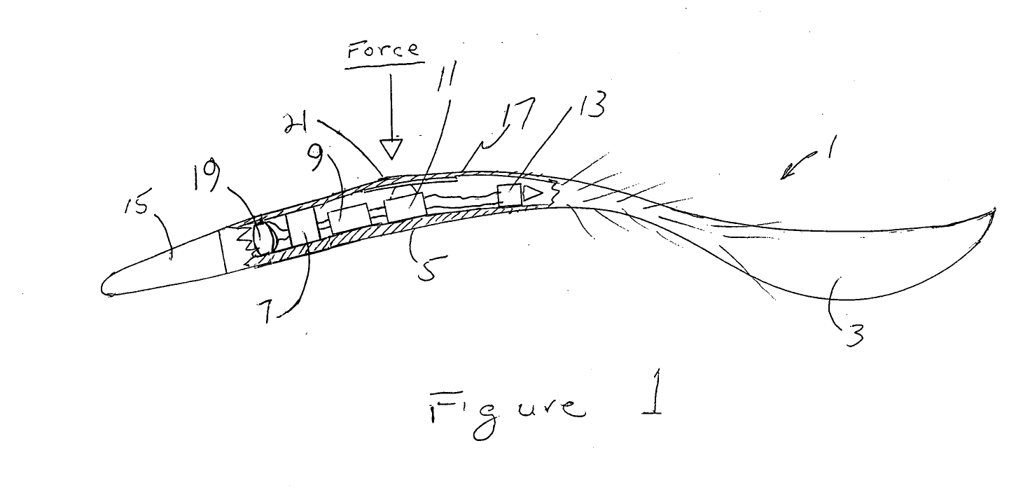

Referring now to the drawings wherein preferred embodiments are presented as examples of the present invention, FIG. 1 shows a partially cut side view of spoon 1. The concave portion 3 also sometimes referred to as the dish or bowl end, has a normal baby spoon shape. Handle portion 5 has a removable tail 15 and is at least partially hollow. There is a motion sensor 7 and a motion sensor-initiated on/off switch 9 connected to battery 19 and to motion activation/deactivation switch 11, and are also connected to light 13, which is directed to concave portion 3. Thus, when the activation/deactivation switch 11 is on so that the motion sensor 7 is functioning and a baby or toddler moves the spoon 1 to eat, the light 13 is illuminated. The top area 21 may be depressed to cause plate 17 to close switch 11, causing the motion sensor to be deactivated. The next time it is depressed, the motion sensor 7 will be reactivated and so on cyclically. The light is directed to and flows toward concave portion 3. Concave portion 3 is typically solid, but may be hollow, translucent or transparent and may be clear or colored. If colored, it may be multi-colored or single colored. The handle portion may be the same as the concave portion or different and may have any of the concave section described color and transparency features.

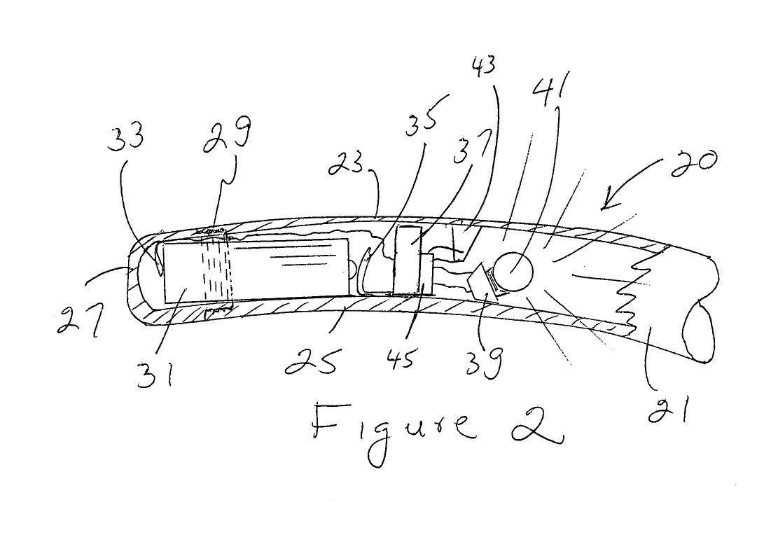

FIG. 2 shows a partially cut partial view of another present invention illuminated washable spoon 20. This embodiment includes a hollow handle portion 21 with an opaque area 23 and a strong bottom 25. It has a removable tail piece 27 with water sealable threads 29. Battery 31 is replaceable and has spring contacts 33 and 35 connected to switch 37, as shown. Motion sensor 37 contains its own internal on/off switch that is an open circuit switch in its rest position. Also included is a music chip 45. The motion sensor 37 and its switch are connected to bulb receiver 39, music chip 45 and waterproof micro speaker 43. When the spoon 20 is moved and motion sensor 37 detects motion, its switch turns on the light and music, encouraging the baby to use the spoon. The motion of use illuminates the bulb 41 and plays a tune through micro speaker 43. This illuminates at least a part of the spoon to the delight of the user.

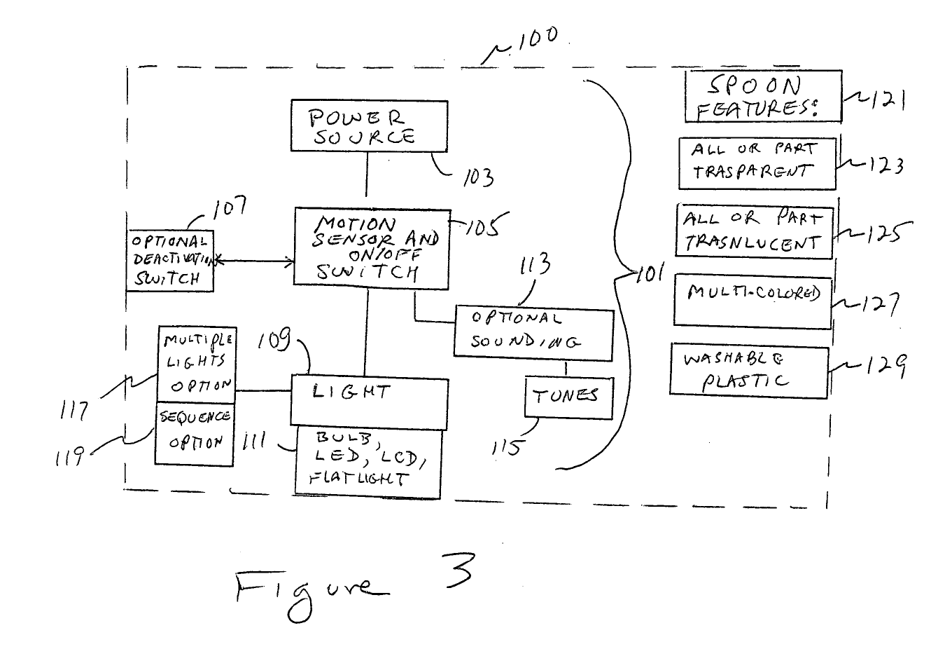

FIG. 3 shows a schematic diagram of various preferred embodiments of present invention spoons represented generally by frame 100. Illumination mechanism 101 involves many features, including power source 103, motion sensor and on/off switch 105, optional motion sensor activation/deactivation switch 107 and light 109. Illumination mechanism 101 also involves bulb, LED, LCD or flatlight 111; optional sounding 113; tunes 115; multiple lights option 117 and sequence option 119. Spoon features 121 include all or part transparent 123, and/or all or part translucent 125, optionally multi-colored 127, and washable plastic 129. The plastic may be any available plastic or plastics that are acceptable for eating food and may be at least partially translucent. Thus, polystyrene, polyethylene, polypropylene, polycarbonate or combinations thereof may be employed.

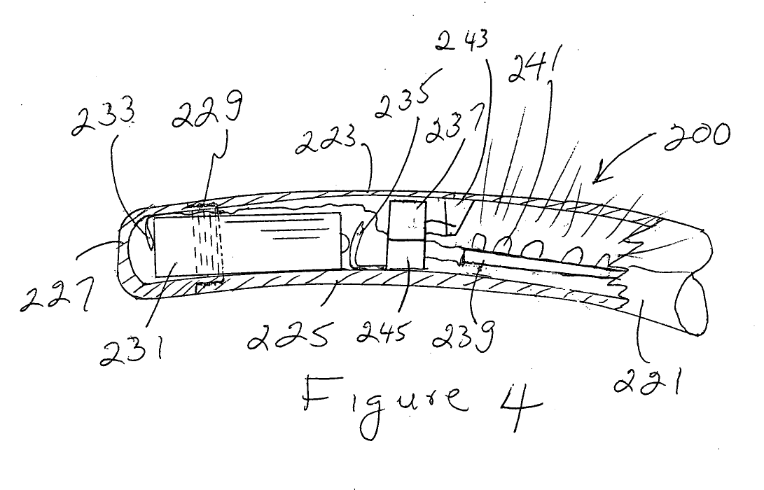

FIG. 4 shows a partially cut partial view of another present invention illuminated washable spoon 200 with multiple light sources. This embodiment includes a hollow handle portion 221 with a motion sensor 237 located in midsection 223. It has a removable tail piece 227 with water sealable threads 229. Battery 231 located at section 225 is replaceable and has spring contacts 233 and 235 connected to motion sensor 237, as shown. The motion sensor 237 and on/off switch 245 operate similarly to those described above, and the switch may include a timer chip or other timer feature to set the time for illumination, after which it will revert to its off mode to shut off the light and sound. Music chip 245 is connected to LED string 239 and water proof micro speaker 243. When motion closes the circuit, the switch causes illumination of the LED's such as LED 241, and the playing of a tune through micro speaker 243. This illuminates at least a part of the spoon to the delight of the user. In one embodiment, all of the LED's illuminate together continuously. In alternative embodiment they could sequence in a prearranged pattern with a control chip or blink simultaneously.

To summarize, the present invention thus provides a unique eating implement for infants and toddlers that both provides entertainment value to the child and motivational value for the child to eat.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. An illuminated washable spoon which comprises:
a.) a main spoon body having a concave distal portion and having a handle portion, at least one of said concave distal portion and handle portion being hollow and having a motion sensor and switch therein with connection to an illumination mechanism and adapted to turn said switch on in response to detected motion;
b.) said illumination mechanism located within said handle portion, said illumination mechanism including a power source, connection to said on/off switch and at least one light, spoon is moved and motion is sensed by said motion sensor, said motion sensor turns on said switch which illuminates said at least one light.

2. The illuminated washable spoon of claim 1 wherein said illumination mechanism includes a timing chip that shuts off said light after a preset illumination time period has transpired.

3. The illuminated washable spoon of claim 1 wherein said handle portion includes a tail section that is removably attached to said handle portion.

4. The illuminated washable spoon of claim 1 wherein said handle portion is translucent at least adjacent said at least one light.

5. The illuminated washable spoon of claim 1 wherein said at least one light is positioned for its illumination to be directed toward said concave distal portion.

6. The illuminated washable spoon of claim 1 wherein said at least one light is positioned for its illumination to be directed toward at least part of said handle portion.

7. The illuminated washable spoon of claim 1 wherein said main spoon body is at least partially transparent.

8. The illuminated washable spoon of claim 1 wherein said main spoon body is completely transparent.

9. The illuminated washable spoon of claim 1 wherein said main spoon body is at least partially translucent.

10. The illuminated washable spoon of claim 1 wherein said main spoon body is multi-colored.

11. The illuminated washable spoon of claim 9 wherein said main spoon body is multi-colored.

12. The illuminated washable spoon of claim 1 wherein said main spoon body is completely translucent.

13. The illuminated washable spoon of claim 12 wherein said main spoon body is multi-colored.

14. The illuminated washable spoon of claim 1 wherein said illumination mechanism further includes a sounding feature connected to said illumination mechanism said that it emits sound simultaneously with illumination of said light.

15. The illuminated washable spoon of claim 14 wherein said sound is a musical tune.

16. The illuminated washable spoon of claim 1 which further includes a and a motion sensor activation/deactivation switch located in said handle and connected to said motion sensor switch that said depressible section may be depressed to cyclically depress said activation/deactivation switch to corresponding activate and deactivate said motion sensor.

17. The illuminated washable spoon of claim 16 wherein said motion sensor and on/off switch renders said illumination mechanism inoperable when said motion sensor is deactivated.

18. The illuminated washable spoon of claim 14 wherein claim 1 which further includes a depressible section in said handle and a motion sensor activation/deactivation switch located at said depressible section and connected to said motion sensor switch that said depressible section may be depressed to cyclically depress said activation/deactivation switch to corresponding activate and deactivate said motion sensor.

19. The illuminated washable spoon of claim 18 where in claim 16 wherein said motion sensor and on/off switch renders said illumination mechanism indispensable when said motion sensor is deactivated.

20. The illuminated washable spoon of claim 1 wherein said main spoon body is formed in two parts that have been permanently bonded and sealed to one another.
